(19) United States
(12) Patent Application Publication
(10) Pub. No.: US 2012/0151818 A1
(43) Pub. Date: Jun. 21, 2012

(54) Tip-down for Ice Fishing

(76) Inventor: Gene C. Orth, Colby, WI (US)

(21) Appl. No.: 13/333,470

(22) Filed: Dec. 21, 2011

Related U.S. Application Data
(60) Provisional application No. 61/425,735, filed on Dec. 21, 2010.

(51) Int. Cl. A01K 97/01; A01K 97/10; A01K 99/00; A01K 97/12

(52) U.S. Cl. 43/4.5; 43/16; 43/21.2

(57) ABSTRACT

An ice fishing apparatus particularly suited to fishing in deeper waters where the ability to reel in a fish without tangling a line. The apparatus is suited to accommodate a wide variety of standard pole and reel configurations. The apparatus also has a hook setting mechanism.

### CROSS REFERENCE TO RELATED APPLICATIONS

This application claims priority from U.S. provisional application #61/425,735 filed 21 Dec. 2010; entitled “Tip-down for ice fishing” The entire contents being hereby incorporated by reference and for which benefit of the priority date is claimed.

### FIELD OF THE INVENTION

The present invention relates to fishing apparatus and in particular ice fishing tip downs.

### BACKGROUND OF THE INVENTION

Ice fishing remains a pleasurable past time for many in polar climates. A popular apparatus for ice fishing is a tip-down. With a tip-down, a pole is placed in an upright position while the fisherman waits for a fish to take bait from the end of a hook attached by line to the end of the pole. The pull of the fish on the line causes the pole to tip downward indicating to the fisherman that a fish is on the line.

The fisherman then pulls the line from the water and retrieves the fish. Ice fishing is mostly done on ice above shallow water. In many cases in colder climates deeper water can also be fished. In these cases having an excess of line is cumbersome to the fisherman, and it is desired that fishing poles of conventional construction and having reels or reeling means be used.

Preferably, the fisherman would enjoy using a reel similar to what is used in summertime fishing, but being a little shorter pole length. In these cases it can be troublesome to find a good balance point for actuating the up/down action required for a tip-down mechanism.

It is therefore an object of the invention to provide a tip-down mechanism comprising a holder suited to adapting with a wide variety of off the shelf fishing poles and reels.

It is therefore an object of the invention to provide a tip-down mechanism having a suitable range of up/down rotational motion.

It is another object of the invention that this structure to provide a holder allowing the fisherman to quickly and easily remove the pole and reel from the holding apparatus in order to play the fish.

It is another object of the invention to provide a trigger mechanism in order to automatically set the hook into the mouth of the fish.

### SUMMARY OF THE INVENTION

In accordance with the present invention, there is provided a mounting bracket for receiving a pole and reel assembly including a hand grip being in association with the bracket and having a fastening member to hold the hand grip to the bracket, and having a trunnion provided at a balance point to provide the operation of tipping the pole assembly when the line is pulled down by a fish.

This ice fishing tip down is designed to be used with commercial ice fishing pole and reel combinations. It allows the fish to be reeled in instead of being pulled in with the line by hand. It eliminates the use of bobbers (which is a benefit as bobbers can freeze into the ice). A tip down of the present invention simplifies deep water fishing as the fisherman does not have to reel in great lengths of line on top of the ice which tangles and blows in the wind. The set up and take down are fast and simple. The present invention is designed to balance just about any ice pole and reel combination, due at least in part to the center of gravity being substantially below the trunnion. The pole and reel can also easily be slid off the stand for easy reeling and has a stop post for limiting rotation of the pole.

In an alternate embodiment, the invention can include a hook setting mechanism for setting a hook into the mouth of a fish when the tip-down is unattended.

The fisherman can leave the hole by some distance as the angle of the pole is easy to see from great distances.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a side perspective view of a typical assembly wherein the pole is in a tip-up orientation;

FIG. 2 is a perspective view of the assembly from FIG. 1 wherein the pole is in a tip-down orientation;

FIG. 3A is a side perspective view of the hook set device wherein the swing arm is in the latched position;

FIG. 3B is a side perspective view of the hook set device wherein the swing arm is in motion after the latch is released;

FIG. 3C is a side perspective view of the hook set device wherein the swing arm is in the open position;

FIG. 4A is an exploded view of the trunnion and mounting bracket with seat assembly;

FIG. 4B is an assembled view of the trunnion and mounting bracket with seat assembly;

FIGS. 5A and B are a perspective view of a trunnion and post assembly;

FIG. 6A is a perspective view of a trunnion, bracket and seat in a tip-up mode showing a representation of the center of gravity;

FIG. 6B is a perspective view of a trunnion, bracket and seat in a tip-down mode showing a representation of the center of gravity.

### DETAILED DESCRIPTION

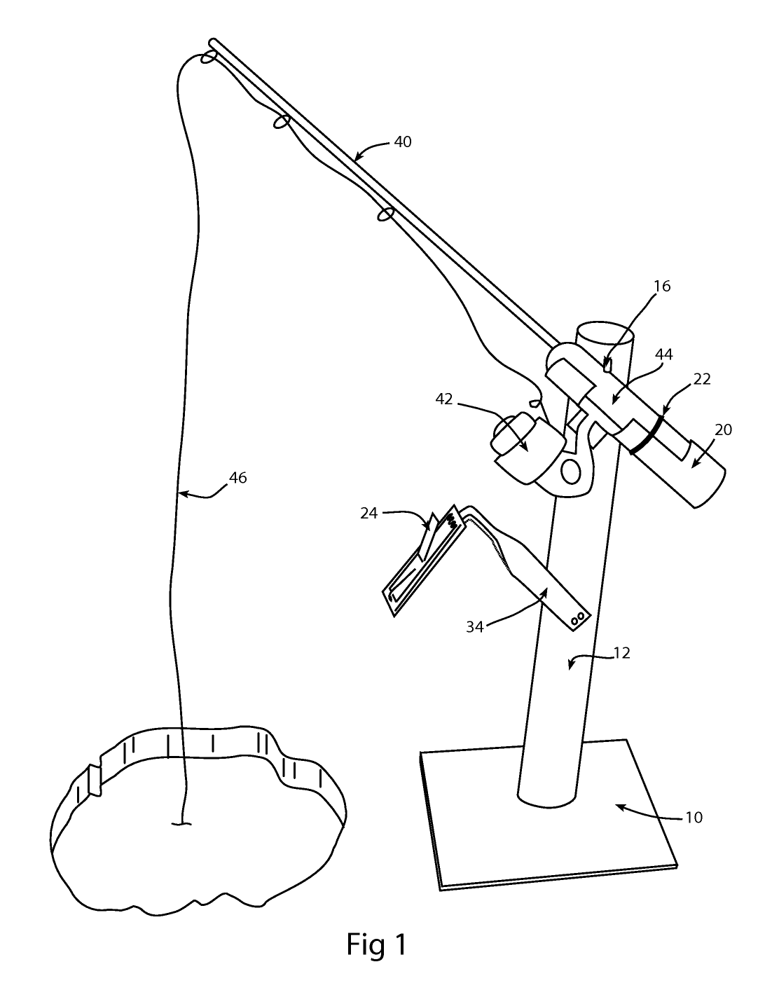

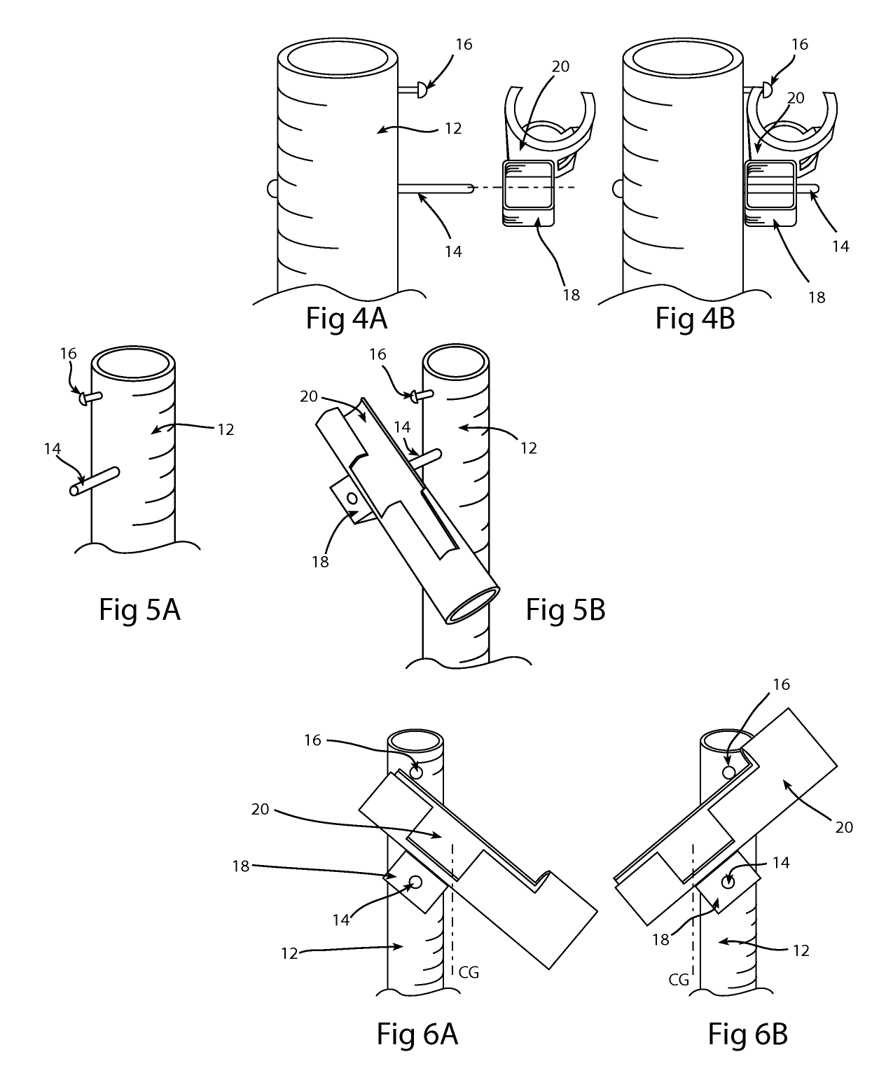

FIG. 1 shows a base (10), which can take a variety of forms including legs, or platforms sufficient to steady the apparatus. The base (10) is connected with a vertical member (12) protruding approximately 18 to 30 inches from the surface of the ice and providing a trunnion (14) for securing a mounting bracket (18) and allowing a focus for rotation (shown in FIGS. 4-6). The mounting bracket (18) is secured to a seat (20). The seat (20) is secured to the handle grip (44) of a fishing pole by means of fastening member (22) which could comprise; a rubber band, Velcro®, tie fasteners or the like. The fishing pole is oriented such that the reel (42) is generally rotated downward providing a low center of gravity or balance which is on the A stop post or rotational stop (16) is provided generally above the trunnion (14) to limit the rotational travel of the pole (40). A line (46) having bait and a hook at the distal end (not shown) is situated along the pole (40) and terminating at the reel (42).

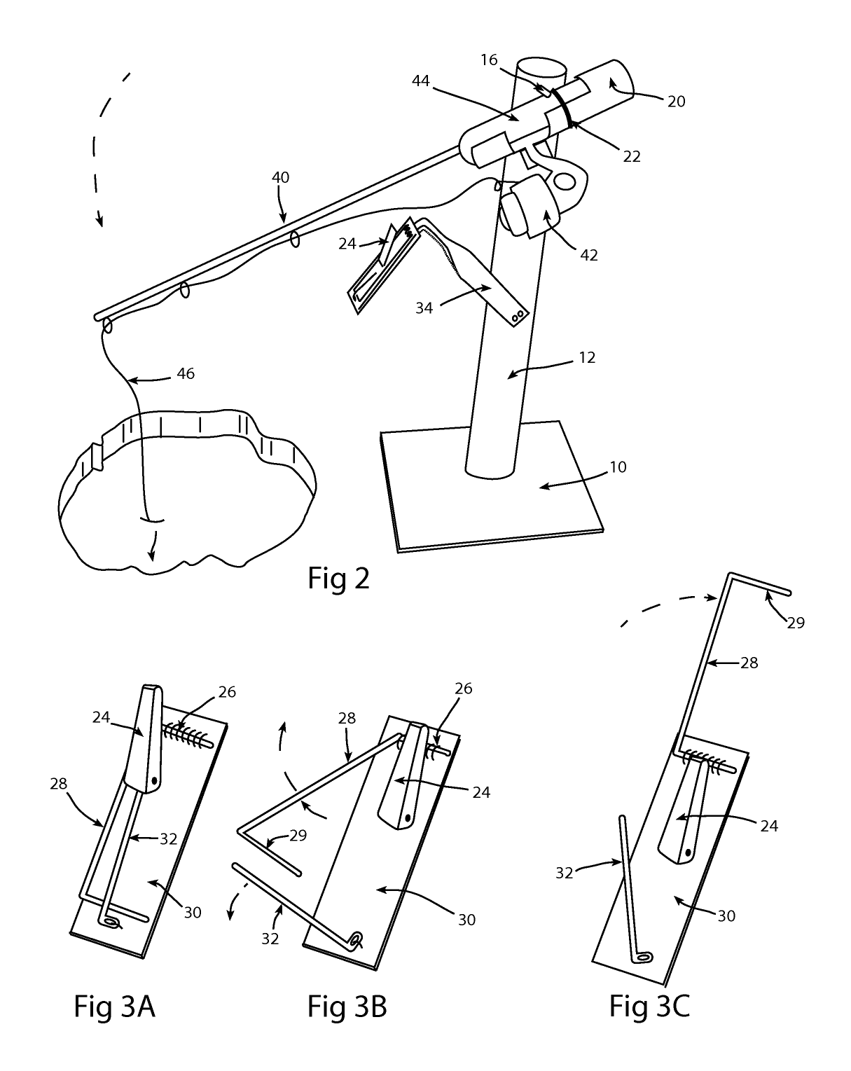

In operation the pole (40) is set up to be oriented at an incline relative to the horizon, or in a ‘tip-up’ position. As a fish discovers the bait and takes the hook, the corresponding movement causes tension on the line (46) pulling it downward into the ‘tip-down’ position as is shown in FIG. 2. When the fisherman sees the pole (40) in the tip-down position, he knows to attend to the line which, in this case, means removing the mounting bracket (18) from the trunnion (14) and reeling in the fish by means of the reel (42).

A hook set mechanism is hereby provided with operation illustrated in FIGS. 3 A-C. The hook set further comprising, a platform (30), a latch member (32) attached at one end to the platform (30) and having a free end capable of moving freely, a trigger (24) for holding the free end of the latch member (32) while in the set position, swing arm (28) having a sweep member (29) and being operatively held in place by the latch member (24) and able to swing in an arcuate movement when released by the latch (24), and a spring (26) capable of imparting kinetic energy to the swing arm

In this embodiment, the fishing pole (40) or seat (20) (depending upon set up and orientation) contacts a trigger (24) which is held in place by a latch member (32). The latch member (32) holds a swing arm (28) in place by means of a spring (26), which in this case is a coil spring (26). The pent up energy in the coil spring (26) causes the swing arm (28) to rotate causing a sweep member (29) generally orthogonal to the swing arm (28) to bump or jerk the pole 40) upward thus setting the hook in the fish's mouth.

FIGS. 6 A&B show a representation of the center of gravity (CG), or center of balance, for a seat (20) with mounting bracket (18) on a trunnion (14). A representation of the pole (40), reel (42), hand grip (44) and line (46) were excluded from the drawing for the sake of simplicity, but it would be understood by one skilled in the art that these would play a part in the completion of the apparatus. In fact, the placement of the pole (40) within the seat (20) affects the center of balance as the center of gravity moves toward the trunnion (14) which acts as a focus or pivot. As the fishing pole moves fore, closing the gap between the center of gravity and the trunnion (14) the more sensitive the balance becomes and less pull on the line (46) would be necessary to rotate the seat (20) from resting against the stop (16) to accelerating toward the tip down position as shown in FIG. 6B. As the fishing pole is moved aft, increasing the gap, the more resistant the pole (40) becomes to pull on the line (46).

One skilled in the art can appreciate that the acceleration of the pole (40) after a slight tug on the line (46) by a fish allows the trigger (24) to reliably activate, and also creates just a little bit of slack on the line (46) such that when the sweep (29) engages the pole (40), it sets the hook (not shown) without ripping the hook from the fish's mouth and settle right back into the tip-down position.

One skilled in the art can also appreciate that the fore and aft adjustment of the pole (40) in the seat (20) can be made after the line (46) is released into the water, allowing the fisherman to manually compensate for length of line (46), fishing weights (not shown), current, and the like when setting the center of balance.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having thus described the invention, what is desired to be protected by Letters Patent is presented in the subsequent appended claims.

We claim:

1. A tip down apparatus for holding a commercial ice fishing pole and reel assembly and setting a hook in a fish; the apparatus comprising:
(i) a vertical member being held by a base and comprising, a trunnion, a rotational stop;
(ii) a seat designed to detachably hold substantially any commercially available ice fishing pole and reel assembly, the pole and reel assembly comprising a tip end and a handle grip end with a fish line extending from the tip end;
(iii) the seat being securely connected with a mounting bracket and the mounting bracket having an interface for removably engaging the mounting bracket with the trunnion;
(iv) the seat in combination with the pole and reel assembly and the mounting bracket being designed to have a center of gravity slightly toward the handle end as mounting bracket is mounted on the trunnion in a set position with the stop limiting rotation of the seat in the set position;
(v) a mechanism for sensing when the pole and reel assembly reaches a predetermined position relative to the vertical member as a fish pulls on the fish line extending from the tip end, whereupon;
(vi) a trigger is activated causing the tip end to set a hook in the mouth of the fish.

2. A tip down apparatus in accordance with claim 1 further comprising a fastening member for securing the handle grip to the seat.

3. A tip down apparatus in accordance with claim 2 wherein the fastening member allows for fore and aft movement of the fishing pole and reel assembly in the seat for adjusting the center of balance

4. A tip down apparatus in accordance with claim 2 wherein the mechanism for sensing when the pole and reel assembly reaches a predetermined position relative to the vertical member further comprising:
(i) an adjustment arm extending from the vertical member holding a hook set;
(ii) the hook set further comprising, a platform, a latch member attached at one end to the platform and having a free end capable of moving, a trigger for holding the free end of the latch member while in the set position, swing arm having a sweep member and being operatively held in place by the latch member and able to swing in an arcuate movement when released by the latch, and a spring capable of imparting kinetic energy to the swing arm.

5. A tip down apparatus in accordance with claim 3 wherein the adjustment arm can be moved to accommodate a variety of predetermined positions relative to the vertical member.

6. A tip down apparatus in accordance with claim 3 wherein the mounting bracket rotates about the trunnion.

7. A tip down apparatus in accordance with claim 6 wherein the center of balance of the seat in combination with the pole and reel assembly and the mounting bracket shifts toward the tip end from the handle end before the pole and reel assembly reaches the predetermined position.

8. A tip down apparatus in accordance with claim 7 wherein the shift in center of balance from the handle end to the tip end causes an angular acceleration of the pole and reel assembly toward the trigger.

9. A tip down apparatus in accordance with claim 8 wherein the acceleration of the pole and reel assembly toward the trigger cases an abrupt snapping motion to the tip end of the pole as the sweep member engages the pole.

10. A method for ice fishing comprising:
(i) setting out a base near an ice fishing hole and situating a vertical member into the base, the vertical member comprising a trunnion and a rotational stop;
(ii) the vertical member further comprising a hook set
(iii) providing a commercially available ice fishing pole and reel assembly, having a tip end and a handle grip end, and removably fastening said assembly to a seat, said seat being firmly attached to a mounting bracket;
(iv) providing a hook set mechanism mounted to the vertical member by means of an adjustment arm;
(v) attaching the mounting bracket to the trunnion by means of a mounting hole;
(vi) adjusting the center of balance of the pole and reel assembly by moving the pole and reel fore or aft relative to the sear to achieve a tip up position having the desired balance point;
(vii) waiting for a fish to pull a line associated with the tip end until the fishing pole contacts the hook set mechanism, whereby;
(viii) a hook is set in the fishes mouth and the pole is situated in the tip-down position signaling a fisherman that a fish is on the line.

11. A method for ice fishing in accordance with claim 10 wherein the relative location of the trunnion and the rotational stop on the vertical member define the arc of travel of the pole.

12. A method of ice fishing in accordance with claim 11 wherein the means of adjusting the center of balance further comprises a sliding fastener.

13. A method of ice fishing in accordance with claim 12 wherein the sliding fastener comprises at the at least one of group of rubber band, Velcro, or tie fasteners.

14. A method of ice fishing in accordance with claim 12 further comprising the fisherman removing the mounting bracket from the trunnion in order to play the fish.

15. A method of ice fishing in accordance with claim 12 wherein the hook set mechanism further comprises; a platform, a latch member attached at one end to the platform and having a free end capable of moving, a trigger for holding the free end of the latch member while in the set position, swing arm having a sweep member and being operatively held in place by the latch member and able to swing in an arcuate movement when released by the latch, and a spring capable of imparting kinetic energy to the swing arm.

16. A method of ice fishing in accordance with claim 15 further comprising adjusting the angle of the adjustment arm relative to the vertical member in order to modulate the angular travel of the pole before triggering the hook set mechanism.

17. A method of ice fishing in accordance with claim 16 wherein the shift in center of balance from the handle end to the tip end causes an angular acceleration of the pole and reel assembly toward the trigger.

18. A method of ice fishing in accordance with claim 17 wherein the acceleration of the pole and reel assembly toward the trigger cases an abrupt snapping motion to the tip end of the pole as the sweep member engages the pole.
